(19) United States
(12) Patent Application Publication
(10) Pub. No.: US 2026/0091413 A1
(43) Pub. Date: Apr. 2, 2026

(54) HEAT SINK THERMAL INTERFACE MATERIAL REMOVAL FIXTURE

(71) Applicant: Aivres Systems Inc., Fremont, CA (US)

(72) Inventor: Jia-Yan WU, New Taipei City (TW)

(21) Appl. No.: 19/412,796

(22) Filed: Dec. 8, 2025

(51) Int. Cl. B08B 1/16; B08B 13/00

(52) U.S. Cl. CPC B08B 1/165; B08B 13/00

(57) ABSTRACT

A fixture for removing thermal interface material from a base surface of a heat sink includes a frame configured to apply a clamping force against the heat sink such that the frame at least partially surrounds the base surface. A guide structure is carried by the frame and extends along at least a portion of the base surface. A scraper assembly, including a scraper body and a scraper element, is movably supported by the guide structure and is configured to contact the base surface. With the frame fixed relative to the heat sink, the scraper assembly is moved along the guide structure to scrape thermal interface material from the base surface.

### TECHNICAL FIELD

This disclosure relates to servicing electronic devices that employ heat sinks, and more particularly to fixtures and methods for removing thermal interface material from a base surface of a heat sink used with heat-generating components.

### BACKGROUND

Electronic devices such as servers, workstations, and networking equipment frequently use heat sinks to dissipate heat from high-power integrated circuits. Thermal interface materials, such as greases or pastes, are applied between a heat sink base and a device package to improve thermal conduction. During validation, rework, or repair, heat sinks are removed and reinstalled many times. Each removal typically requires the old thermal interface material to be cleaned from the heat sink base before fresh material is applied.

In practice, technicians often use improvised tools such as metal rulers, utility blades, plastic cards, or generic scrapers to remove the residue (some examples are illustrated in FIG. 1). These tools are not designed for controlled, uniform contact with the heat sink base. If the scraping force or angle varies, the hard edge of the tool can scratch or gouge the base surface, degrading flatness and increasing thermal resistance. At the same time, many of these tools have exposed sharp edges that are manipulated close to the operator’s fingers and palm. Slips are common when working around viscous thermal grease on a small, awkwardly held part, which increases the risk of cuts and other personal injury. Effective cleaning therefore depends heavily on operator skill and care, and even experienced technicians may apply inconsistent pressure or angle over repeated operations. The problem is exacerbated in test and validation environments where processors or chips are swapped frequently and the same heat sink needs to be cleaned every time.

Heat sinks for different packages, power levels, and manufacturers vary widely in footprint, thickness, and edge geometry. There is no universal fixture that can accommodate this range of dimensions while still securely referencing the plane of the base surface. Existing scrapers are essentially hand tools without adjustable frames or corner references, so they cannot be quickly adapted to new heat sink sizes and do not maintain a consistent scraping plane or contact path. As a result, there is no existing tool that can be applied across different heat sinks to remove thermal interface material safely, efficiently, and repeatably.

### SUMMARY

A general aspect of the disclosure is a fixture for removing thermal interface material from a base surface of a heat sink. The fixture includes a frame configured to apply a clamping force against the heat sink such that the frame at least partially surrounds the base surface, a guide structure carried by the frame and extending along at least a portion of the base surface, and a scraper assembly movably supported by the guide structure. The scraper assembly includes a scraper body and a scraper element coupled to the scraper body and configured to contact the base surface. The scraper assembly is movable along the guide structure to scrape thermal interface material from the base surface while the frame remains fixed relative to the heat sink.

Implementations may include one or more of the following features. In some implementations, the frame includes plurality of side rail assemblies joined end-to-end to define a substantially rectangular opening sized to receive the heat sink such that the base surface is exposed through the opening. Each side rail assembly may include a first rail portion and a second rail portion that are telescopically received one within the other to permit adjustment of a length of the side rail assembly. For each side rail assembly, a biasing element may extend between the first rail portion and the second rail portion and be configured to urge the first rail portion and the second rail portion toward a retracted configuration in which the first rail portion and the second rail portion overlap along a majority of their lengths. The biasing element of each side rail assembly may include a tension spring extending generally along the corresponding side rail assembly and having opposed ends respectively attached to the first rail portion and the second rail portion. Pulling diagonally opposite corners of the frame away from one another can extend at least two of the plurality of side rail assemblies against the biasing elements to enlarge the rectangular opening, and releasing the diagonally opposite corners allows the biasing elements to return the side rail assemblies toward the retracted configuration to apply the clamping force against side surfaces of the heat sink.

The fixture may further include a plurality of corner members respectively coupled to adjacent ones of the side rail assemblies. Each corner member can be perpendicular to a plane defined by the plurality of side rail assemblies and can include at least one positioning surface configured to engage a corresponding corner region of the heat sink and locate the frame relative to the base surface. At least one of the corner members may include an anti-slip pad configured to frictionally engage the heat sink and resist relative movement between the frame and the heat sink during scraping. The guide structure may include a pair of substantially parallel guide grooves formed in opposed side rail assemblies of the frame, and the scraper assembly may include a pair of guide rods respectively received in the pair of guide grooves. The scraper assembly can be coupled to the guide structure by a joint that permits rotation of the scraper body about an axis defined by the pair of guide rods to vary an angle of the scraper element relative to the base surface. The scraper element may include an elastomeric strip having a scraping edge configured to contact and remove the thermal interface material from the base surface. The scraper body may define a mounting slot configured to releasably retain the elastomeric strip such that the elastomeric strip is replaceable. The scraper assembly may further include a handle configured to be grasped by an operator and to transmit a scraping force to the scraper element as the scraper assembly is moved along the guide structure. At least one of the scraper body and the handle may include a textured surface pattern configured to improve manual grip on the scraper assembly, and at least one surface of the scraper body may include a surface pattern configured to improve manual grip on the scraper assembly. The frame and the guide structure may cooperate to position a contact edge of the scraper element in a plane substantially coincident with the base surface when the clamping force is applied. In some implementations, the fixture further includes a drive mechanism configured to move the scraper assembly along the guide structure. The drive mechanism may include an electric motor and a transmission coupled between the electric motor and the scraper assembly to translate rotary motion of the electric motor into linear movement of the scraper assembly along the guide structure. Implementations of the described techniques may be realized in hardware structures and mechanical processes.

In another general aspect, a method of removing thermal interface material from a base surface of a heat sink includes providing a fixture having a frame configured to apply a clamping force against the heat sink such that the frame at least partially surrounds the base surface, a guide structure carried by the frame and extending along at least a portion of the base surface, and a scraper assembly movably supported by the guide structure and having a scraper body and a scraper element coupled to the scraper body and configured to contact the base surface. The method also includes positioning the frame relative to the heat sink such that the frame at least partially surrounds the base surface, applying the clamping force with the frame against the heat sink such that the frame remains fixed relative to the heat sink, and moving the scraper assembly along the guide structure while the scraper element is in contact with the base surface, thereby scraping the thermal interface material from the base surface.

Implementations of the method may include one or more of the following features. Applying the clamping force may include pulling opposing corners of the frame away from one another to extend at least two side rail assemblies of the frame against respective biasing elements to enlarge a substantially rectangular opening of the frame, positioning the heat sink within the substantially rectangular opening, and releasing the opposing corners to allow the biasing elements to return the side rail assemblies toward the retracted configuration in which the side rail assemblies apply the clamping force against side surfaces of the heat sink. Implementations of the described techniques may be realized as mechanical systems, methods, or processes.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates examples of improvised tools used to remove thermal interface material, including a plastic ruler, metal ruler, plastic scraper, and razor scraper.

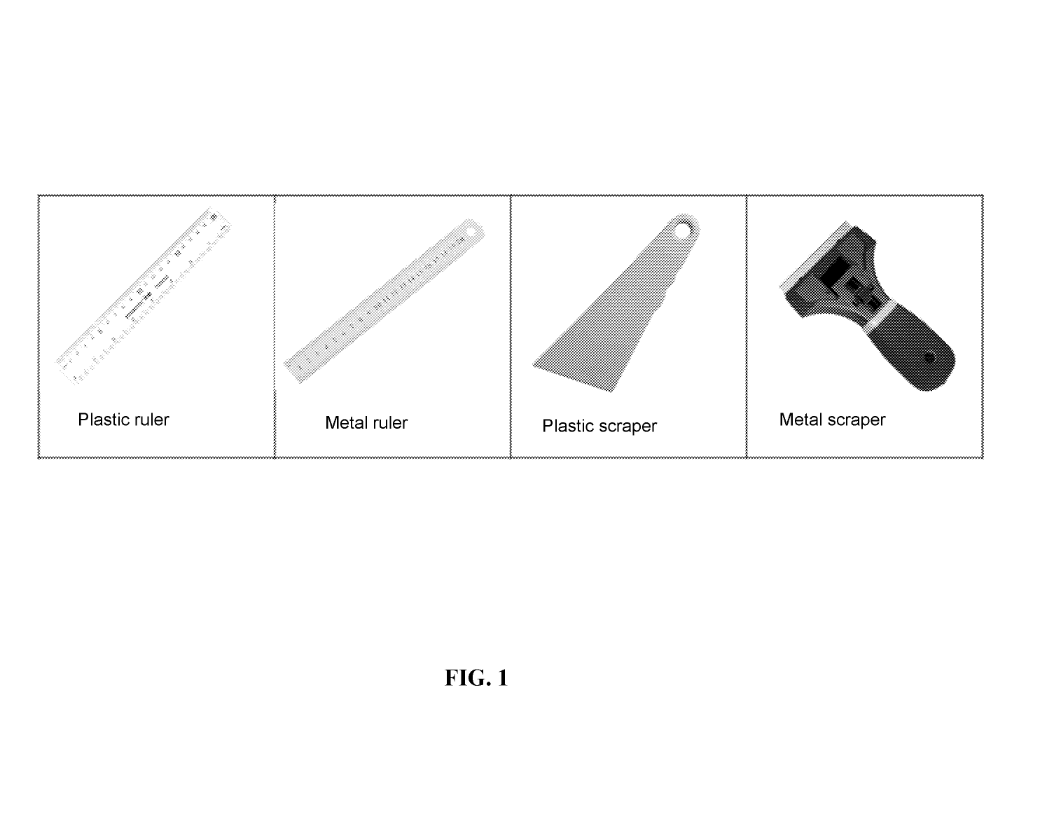

FIG. 2 illustrates example heat sink assemblies with heat pipes and thermal interface material applied between a device package and a base surface of a heat sink, in accordance with some embodiments.

FIG. 3A shows two perspective views of a thermal interface material removal fixture having a spring-biased telescopic frame and a sliding rubber scraper assembly, in accordance with some embodiments.

FIG. 3B illustrates a thermal interface material removal fixture with a heat sink received in the frame and an enlarged view of a corner member having positioning and anti-slip structures, in accordance with some embodiments.

FIG. 4A illustrates a top view of a thermal interface material removal fixture having spring-biased telescopic side rail assemblies and a guide structure with guide grooves and guide rods that support a scraper assembly, in accordance with some embodiments.

FIG. 4B illustrates top views of the thermal interface material removal fixture in a neutral position and in an expanded position for clamping heat sinks of different sizes, in accordance with some embodiments.

FIG. 5 illustrates a perspective view of the thermal interface material removal fixture deployed on a representative heat sink assembly that includes heat pipes and a remote-side heat sink fin assembly, in accordance with some embodiments.

FIG. 6 illustrates side views showing movement of a scraper assembly across a base surface of a heat sink while the frame remains clamped to the heat sink, in accordance with some embodiments.

FIG. 7 illustrates an enlarged perspective view of a side rail assembly having telescoping rail portions with aligned guide grooves that receive a guide rod of a guide structure, in accordance with some embodiments.

FIG. 8A illustrates a front view of an example scraper assembly including a scraper body, an elastomeric scraper element, guide-rod engagement channels, and a handle with surface patterns configured to improve grip, in accordance with some embodiments.

FIG. 8B illustrates an exploded perspective view of the scraper body and a removable scraper element, highlighting a mounting slot in the scraper body that releasably retains the scraper element, in accordance with some embodiments.

FIG. 9 illustrates a side view showing that the scraper assembly can rotate about a guide-rod axis through a range of angles to accommodate different scraping directions and contact pressures, in accordance with some embodiments.

FIG. 10 illustrates a flow diagram of a process for removing thermal interface material from a base surface of a heat sink using the thermal interface material removal fixture, in accordance with some embodiments.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

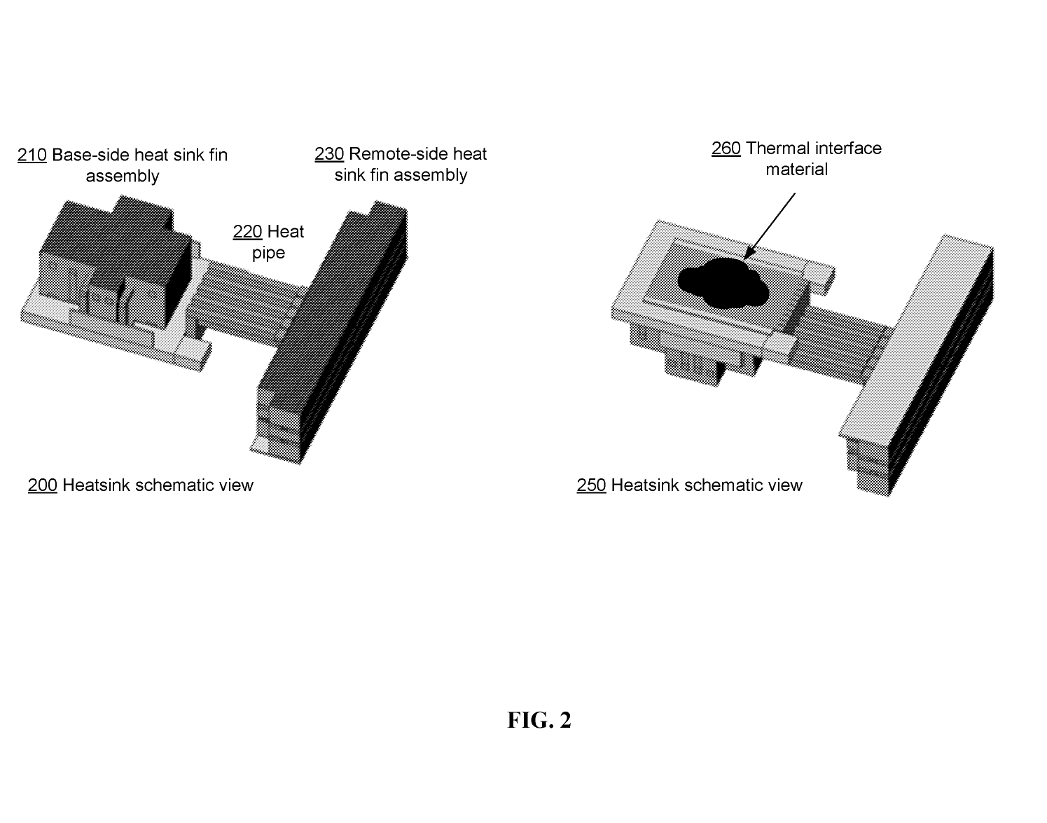

FIG. 2 illustrates example heat sink assemblies with heat pipes and thermal interface material applied between a device package and a base surface of a heat sink, in accordance with some embodiments.

In this figure, the heatsink schematic view 200 illustrates an example heat sink configuration in which a base-side heat sink fin assembly 210 is thermally coupled to a remote-side heat sink fin assembly 230 by one or more heat pipes 220. In use, a base surface of the base-side heat sink fin assembly 210 is mounted to an electronic device such as a processor package (not shown), and heat generated by the electronic device is conducted into the base-side heat sink fin assembly 210. The heat pipes 220 extend between the base-side heat sink fin assembly 210 and the remote-side heat sink fin assembly 230 to transfer heat away from the device region and distribute the heat into the larger remote fin structure, where it is dissipated to the surrounding air via convection, using liquid cooling, or using a combination of both.

The second heatsink schematic view 250 illustrates thermal interface material 260 disposed on the base surface of the base-side heat sink fin assembly 210. During installation of the electronic device and the heat sink, the thermal interface material 260 is interposed between the base surface of the heat sink and an opposing surface of the electronic device. The thermal interface material 260 fills surface irregularities and eliminates air gaps that would otherwise exist between the two mating surfaces. Because air is a poor thermal conductor, these gaps would significantly increase thermal resistance. By conforming to both surfaces, the thermal interface material 260 improves thermal contact and reduces the overall thermal resistance between the electronic device and the heat sink, thereby enhancing cooling performance.

When the electronic device is removed for replacement, servicing, or testing, the thermal interface material 260 typically remains adhered to the base surface of the base-side heat sink fin assembly 210 and to the removed device. The material may be partially dried, unevenly spread, or contaminated with dust and debris. Reusing this residual thermal interface material 260 can lead to voids, trapped air, and non-uniform thickness when a new device is mounted, which significantly degrades thermal performance and may cause local overheating of the device. Accordingly, before a new electronic device is installed or a previously removed device is reinstalled, the residual thermal interface material 260 on the base surface of the heat sink must be removed and the surface cleaned so that a fresh, uniform layer of thermal interface material can be applied. This repeated cleaning step motivates the need for a dedicated removal fixture that can safely and consistently scrape the thermal interface material from the heat sink base.

In the following description, various components are labeled for ease of understanding, including:

Frame 310.

Four side rail assemblies 320 joined end-to-end to define a substantially rectangular opening.

First rail portion 322.

Second rail portion 323.

Telescopic interface 324 between the first and second rail portions.

Biasing element 330 (e.g., a tension spring extending along the side rail direction, with opposed ends attached to the first and second rail portions).

Corner members 340 coupled to adjacent side rail assemblies, oriented perpendicular to a plane defined by the four side rail assemblies, configured to frictionally engage the heat sink, and resist relative movement between the frame 310 and the heat sink during scraping.

Guide structure 350.

Pair of substantially parallel guide grooves 352 formed in opposed side rail assemblies of the frame 310.

Pair of guide rods 354 respectively received in the pair of guide grooves 352 of the guide structure 350, defining an axis about which the scraper body 410 can rotate.

Scraper assembly 400.

Scraper body 410.

Scraper element 415 (e.g., elastomeric strip) configured to contact and remove thermal interface material from the base surface.

Mounting slot 420 releasably retains the scraper element 415 to the scraper body 410 so the scraper element 415 is replaceable.

Surface pattern 430 on at least one surface of the scraper body 410, configured to improve manual grip on the scraper assembly.

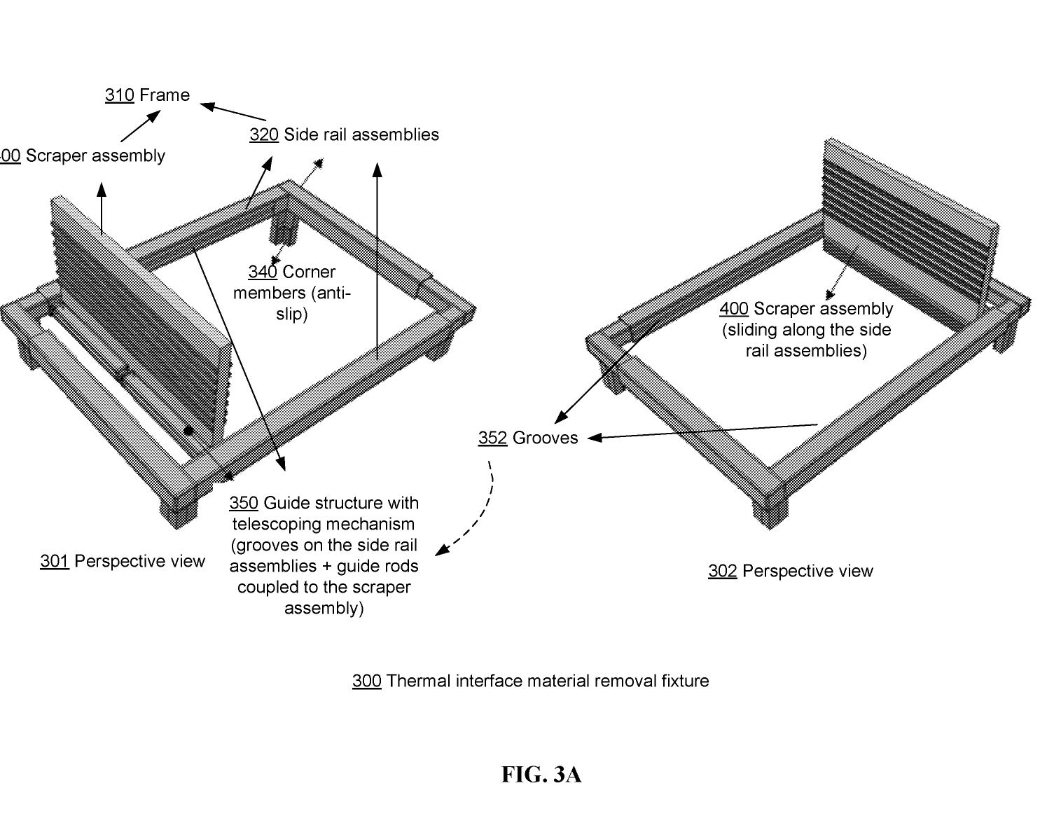

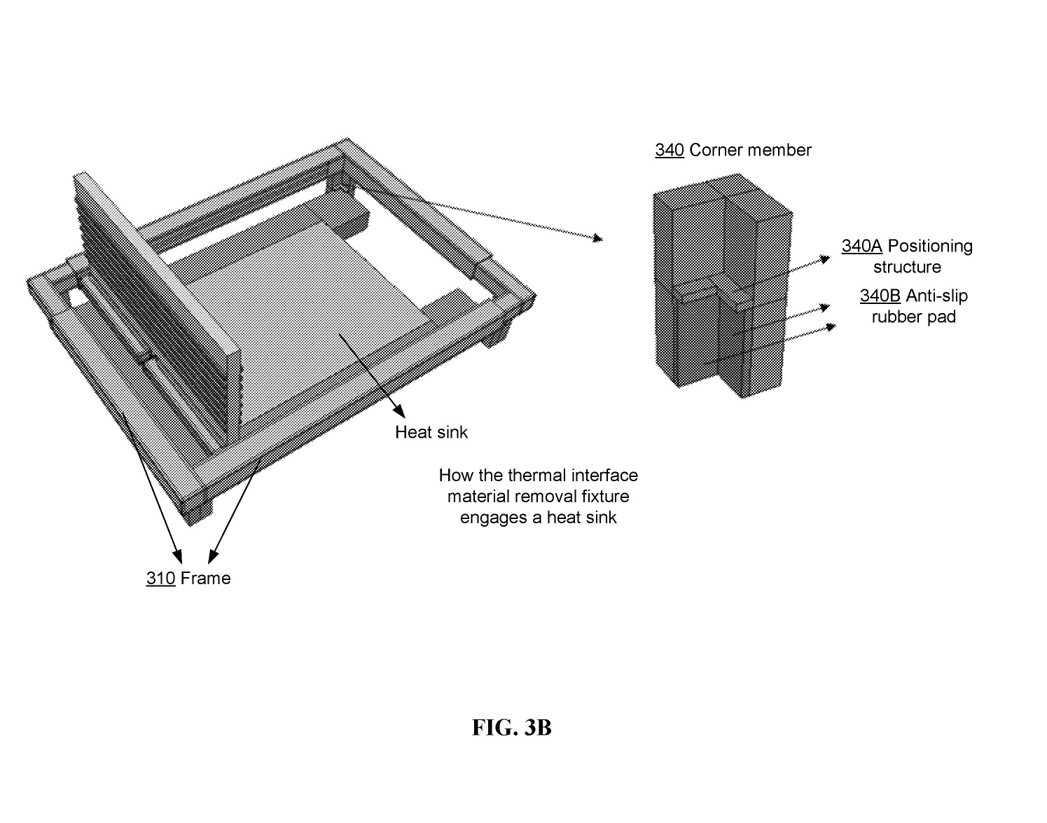

FIG. 3A illustrates two perspective views 301 and 302 of a thermal interface material removal fixture 300, in accordance with some embodiments. In this embodiment, the fixture 300 includes a frame 310 configured to apply a clamping force against a heat sink such that the frame 310 at least partially surrounds a base surface of the heat sink when in use.

In some embodiments, the frame 310 includes four side rail assemblies 320 joined end-to-end to define a substantially rectangular opening sized to receive the heat sink so that the base surface of the heat sink remains exposed through the opening for scraping. Corner members 340 are coupled to adjacent ones of the side rail assemblies 320 and project perpendicular to a plane defined by the side rail assemblies 320. Each corner member 340 provides one or more positioning surfaces that engage a corresponding corner region of the heat sink to locate the frame 310 relative to the base surface of the heat sink, and at least one corner member 340 may include an anti-slip structure that frictionally engages the heat sink and resists relative movement between the frame 310 and the heat sink during scraping.

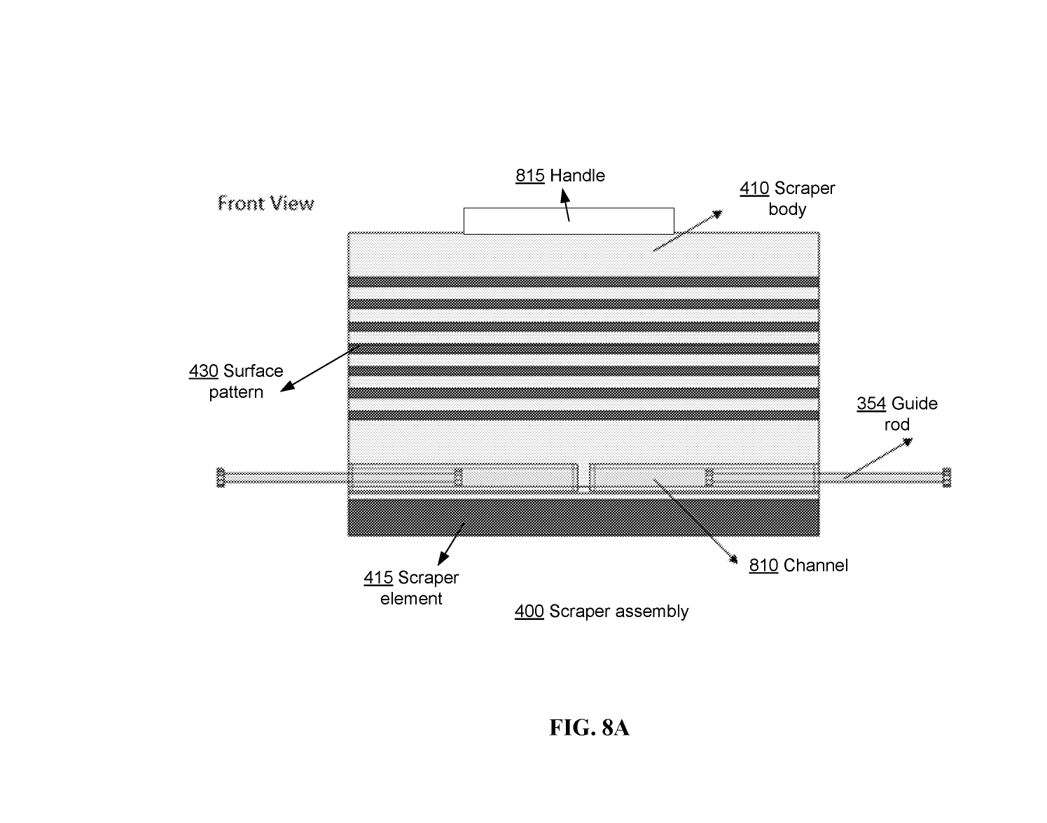

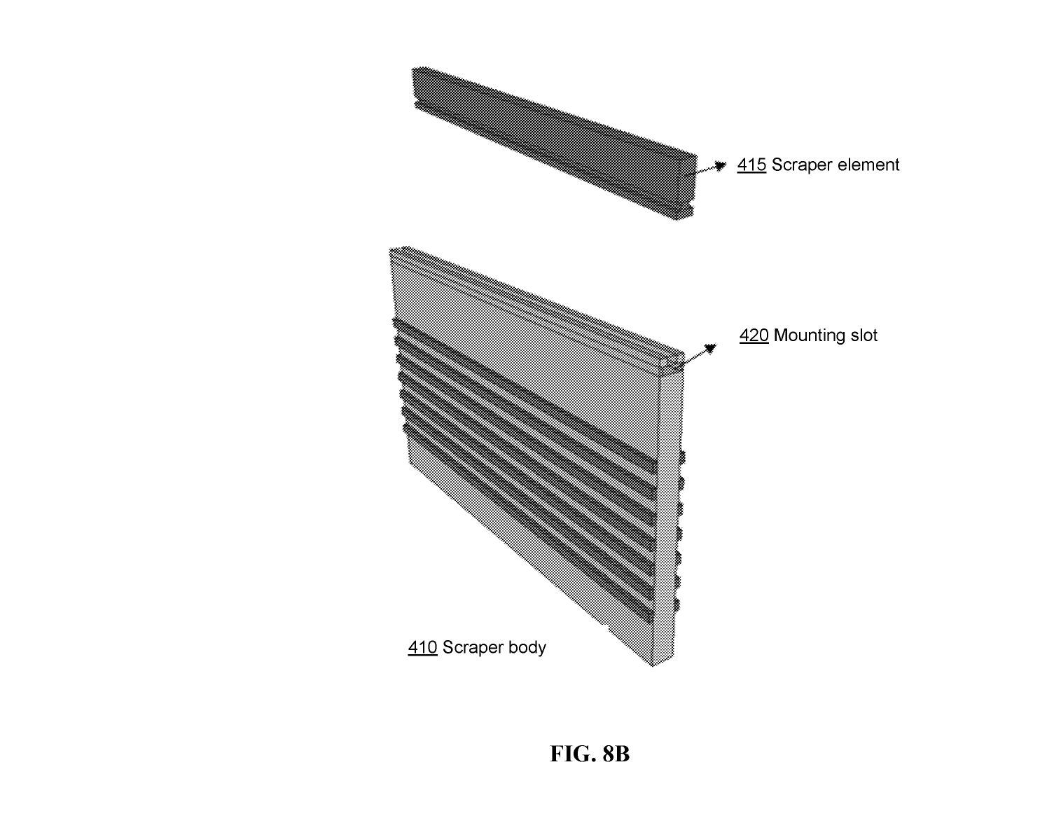

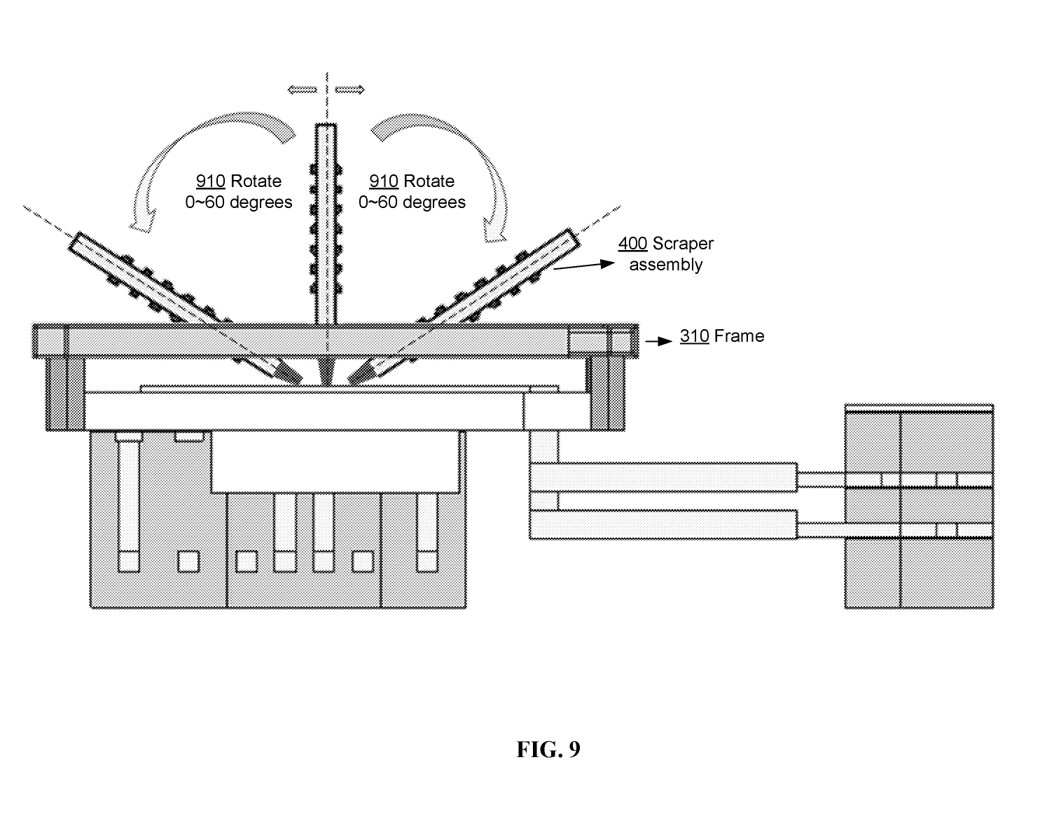

In addition, a guide structure 350 may be carried by the frame 310 and extend along at least a portion of the rectangular opening. In the illustrated embodiment, the guide structure 350 includes a pair of substantially parallel guide grooves 352 formed in two opposed side rail assemblies 320 and a pair of guide rods that are slidably received in the guide grooves 352 (see, e.g., FIGS. 8 and 9A).

A scraper assembly 400 is supported by the guide structure 350, e.g., using the guide rods. The scraper assembly 400 includes a scraper body and a scraper element (see, e.g., FIGS. 9A and 9B) and configured to contact the base surface of the heat sink. For example, the scraper body 410 is coupled to the guide rods 354 of the guide structure 350, allowing the scraper assembly 400 to slide along the guide structure 350 while the frame 310 remains fixed relative to the heat sink, thereby scraping thermal interface material from the base surface.

Note that even though the illustrated frame 310 includes four side rail assemblies 320 that together form a rectangle sized to receive the heat sink, the number and arrangement of side rail assemblies 320 are not limiting. In some embodiments, two opposite sides of the frame 310 are implemented as telescoping side rail assemblies 320, while the remaining sides are fixed-length members that cooperate with the telescoping sides to define the opening. In other embodiments, the frame 310 may include three side members that partially surround the heat sink base surface while still providing a clamping function. Among the three side members, all of them may be side rail assemblies 320, or the middle one may be the only side rail assembly 320.

FIG. 3B illustrates an example corner member of the thermal interface material removal fixture for engaging a heat sink, in accordance with some embodiments.

In this figure, the thermal interface material removal fixture is shown with a heat sink received within the rectangular opening defined by the frame 310. The heat sink is positioned so that its base surface faces upward for scraping. When the frame 310 applies a clamping force in use, the corners the heat sink are urged toward the corresponding corner regions of the frame 310.

An enlarged view on the right of FIG. 3B illustrates a corner member 340 in a corner region of the frame 310 in greater detail. In some embodiments, the corner member 340 has an L-shaped profile when viewed from above, with two legs that extend along respective ones of the adjacent side rail assemblies 320. A positioning structure 340A projects inward from the corner region and provides one or more positioning surfaces that contact two perpendicular side surfaces at the corner region of the heat sink to locate the heat sink within the frame 310. In some embodiments, an anti-slip rubber pad 340B is provided on a side of the corner member 340 facing the heat sink. The anti-slip rubber pad 340B frictionally engages the corners of the heat sink so that, when the frame 310 is clamped, the heat sink is locked in place and stabilized against lateral movement during scraping of thermal interface material.

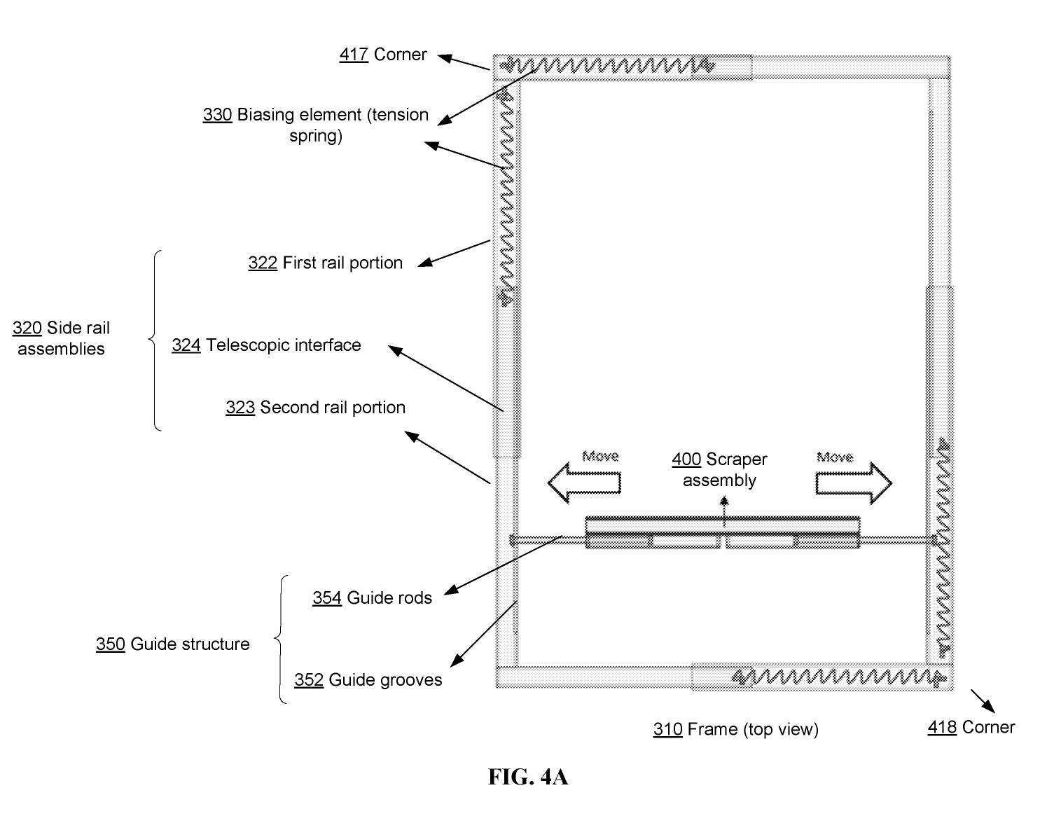

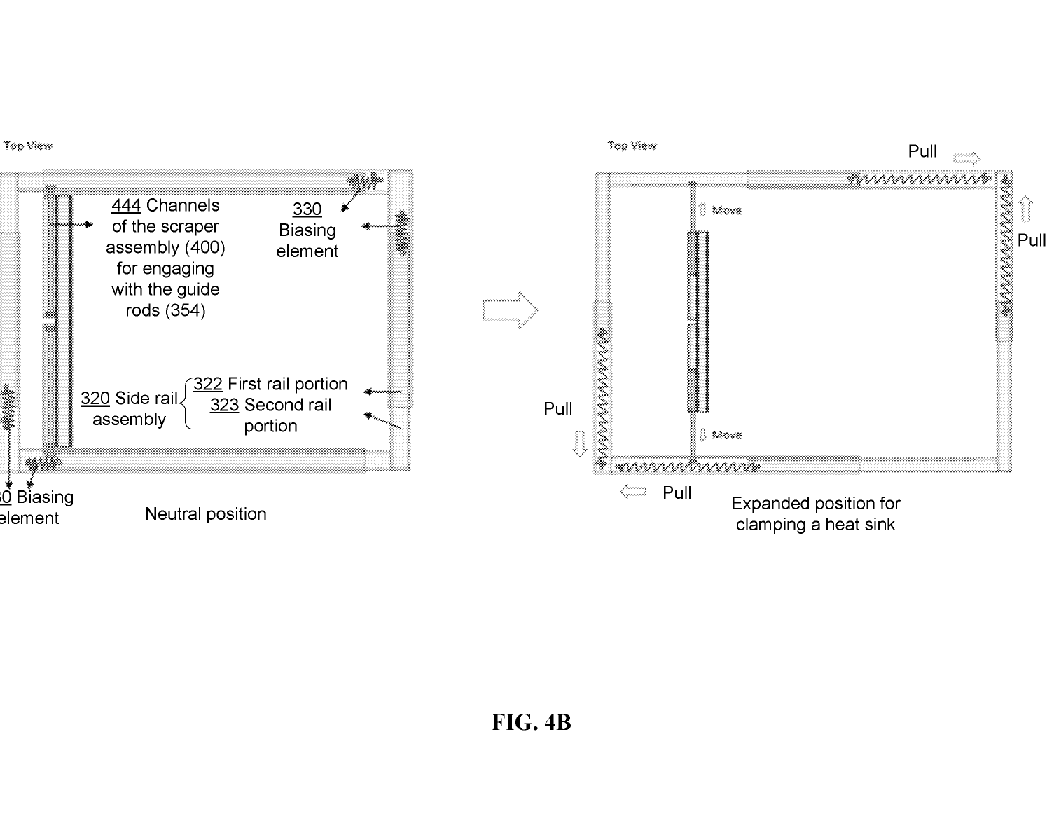

FIG. 4A illustrates a top view of the frame 310 of a thermal interface material removal fixture 300 with side rail assemblies 320 and a guide structure 350 for a scraper assembly 400, in accordance with some embodiments.

Referring to FIG. 4A, the frame 310 is formed by four side rail assemblies 320 joined end-to-end to define a substantially rectangular opening for receiving a heat sink. Each side rail assembly 320 includes a first rail portion 322 and a second rail portion 323 that at least partially overlap along their lengths and define a telescopic interface 324. In some embodiments, the telescopic interface 324 is formed by complementary channel and guide profiles so that one of the rail portions (for example, the second rail portion 323) is slidably received within a hollow section of the other rail portion (for example, the first rail portion 322), maintaining alignment of the two portions while permitting relative longitudinal motion. The telescopic interface 324 permits the effective length of each side rail assembly 320 to be increased or decreased as the first and second rail portions 322, 323 slide relative to one another, while still transmitting clamping forces around the perimeter of the frame 310 and resisting out-of-plane bending or twisting as the frame 310 is expanded and released.

A biasing element 330, implemented here as a tension spring, is disposed within each side rail assembly 320 and extends generally along a longitudinal direction of the side rail assembly 320 between the first rail portion 322 and the second rail portion 323. In some embodiments, the tension spring 330 is substantially enclosed by the side rail assembly 320. Opposite ends of the biasing element 330 are respectively anchored to the first rail portion 322 and the second rail portion 323 at locations near the facing ends of the first and second rail portions within the telescopic interface 324. Because the biasing element 330 is in tension along the length of the side rail assembly 320, it urges the first and second rail portions 322, 323 toward one another so that, in an unbiased or relaxed configuration, the rail portions overlap along a majority of their lengths (e.g., over 50%). To mount (clamp) a heat sink, an operator can pull two diagonally opposite corners 417 and 418 of the frame 310 away from one another, thereby extending at least two of the side rail assemblies 320 against the tension of the corresponding biasing elements 330 and enlarging the rectangular opening. After the heat sink is positioned within the opening, releasing the diagonally opposite corners 417 and 418 allows the biasing elements 330 to retract the side rail assemblies 320 toward the retracted configuration (also called natural or relaxed configuration) and apply a clamping force against side surfaces of the heat sink, fixing the frame 310 relative to the base surface of the heat sink.

FIG. 4A also illustrates a guide structure 350, which includes a pair of guide grooves 352 that extend along the inner sides of corresponding opposed side rail assemblies 320, and a pair of guide rods 354 are slidably received in the guide grooves 352 and form part of the support for a scraper assembly 400. As shown, the scraper assembly 400 substantially spans the rectangular opening and is coupled to the guide rods 354 such that it can move laterally along the pair of guide rods 354, as indicated by the “Move” arrows. In some embodiments, the coupling between the scraper assembly 400 and the guide rods 354 further permits the scraper body to rotate about an axis defined by the guide rods 354 to adjust the attack angle of a scraper element while the scraper assembly 400 is translated across the base surface of the heat sink.

FIG. 4B is a set of top views of a thermal interface material removal fixture illustrating a neutral position and an expanded position for clamping a heat sink, in accordance with some embodiments.

Referring to FIG. 4B, the left-hand view shows the fixture (e.g., 300) in a neutral or relaxed configuration. In this state, the biasing elements 330 (tension springs) within the side rail assemblies 320 are relaxed and draw the first rail portions 322 and the second rail portions 323 toward one another so that they substantially overlap along their lengths. The rectangular opening defined by the frame is relatively small and suited for a smaller heat sink. In this position, guide rods 354 of the guide structure 350 span a corresponding width of the opening. The scraper assembly 400 is supported by the guide rods 354 via channels 444 formed in the scraper assembly 400. The channels 444 receive and capture the guide rods 354 so that the scraper assembly 400 remains slidably engaged with the rods while also being able to rotate slightly about the rod axis to adjust its scraping angle.

The right-hand view of FIG. 4B illustrates the fixture (e.g., 300) in an expanded position for clamping a larger heat sink. By pulling outward on the corners of the frame 310, an operator extends the first and second rail portions 322, 323 of at least two of the side rail assemblies 320 against the tensile force of the biasing elements 330. This sliding motion between the first and second rail portions 322 and 323 increases the length of the side rail assemblies 320 and enlarges the rectangular opening so that a larger heat sink can be received. Because the guide rods 354 are coupled to the side rail assemblies 320, the rods extend along with the rail portions as the frame expands. The channels 444 of the scraper assembly 400 remain engaged with the guide rods 354 throughout this motion, so the scraper assembly 400 stays supported by the guide structure 350 regardless of the frame size.

Once the heat sink is positioned within the enlarged opening, releasing the corners allows the biasing elements 330 to retract the side rail assemblies 320 toward the neutral configuration and apply a clamping force against the side surfaces of the heat sink (as indicated by the “Pull” arrows). With the frame 310 clamped, the scraper assembly 400 can be translated along the guide rods 354, as indicated by the “Move” arrows. In some embodiments, the width of the scraper assembly 400 is less than the full dimension of the exposed base surface of the heat sink. The sliding engagement between the channels 444 and the guide rods 354 allows an operator to move the scraper assembly 400 to different lateral positions so that successive passes can scrape thermal interface material from different regions of the base surface until the entire surface has been cleaned.

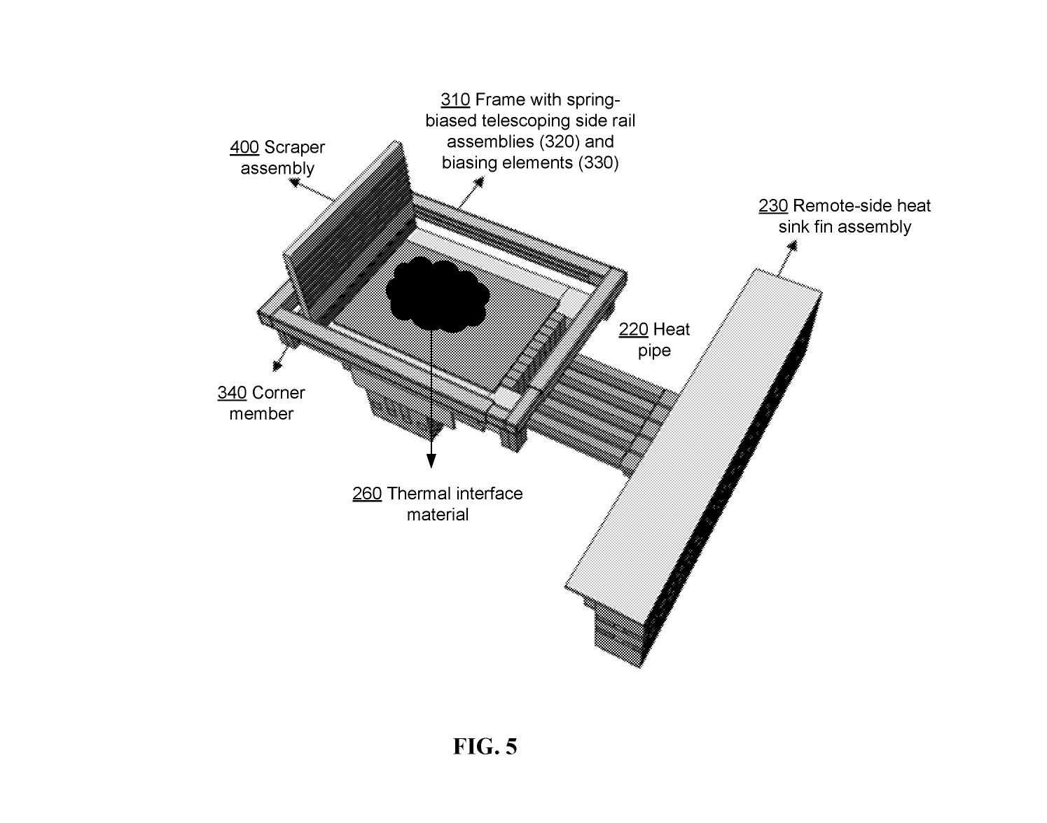

FIG. 5 is a perspective view illustrating deployment of the thermal interface material removal fixture 300 on a heat sink assembly. In this example, a frame 310 with spring-biased telescoping side rail assemblies 320 and internal biasing elements 330 is clamped around the base portion of the heat sink. Corner members 340 at the corners of the frame 310 engage the corner regions of the heat sink to position and stabilize the frame 310 so that the base surface of the heat sink remains exposed within the rectangular opening. Thermal interface material 260 is shown on the exposed base surface above an underlying electronic device package (not visible in this view).

The heat sink assembly further includes one or more heat pipes 220 that extend from the base region to a remote-side heat sink fin assembly 230. During operation, heat generated by the electronic device is conducted through the thermal interface material 260 into the base surface of the heat sink, carried along the heat pipes 220 to the remote-side fin assembly 230, and dissipated to the surrounding environment by convection—such as to ambient air, to a cooling liquid flowing across the fins, or to a combination of both. With the frame 310 clamped in place, a scraper assembly 400 spans the opening of the frame 310 and is supported by the guide structure so that it can be translated across the thermal interface material 260. An operator can move the scraper assembly 400 while the heat sink and frame 310 remain stationary, allowing the scraper assembly 400 to progressively remove the thermal interface material 260 from the base surface without disturbing the heat sink assembly.

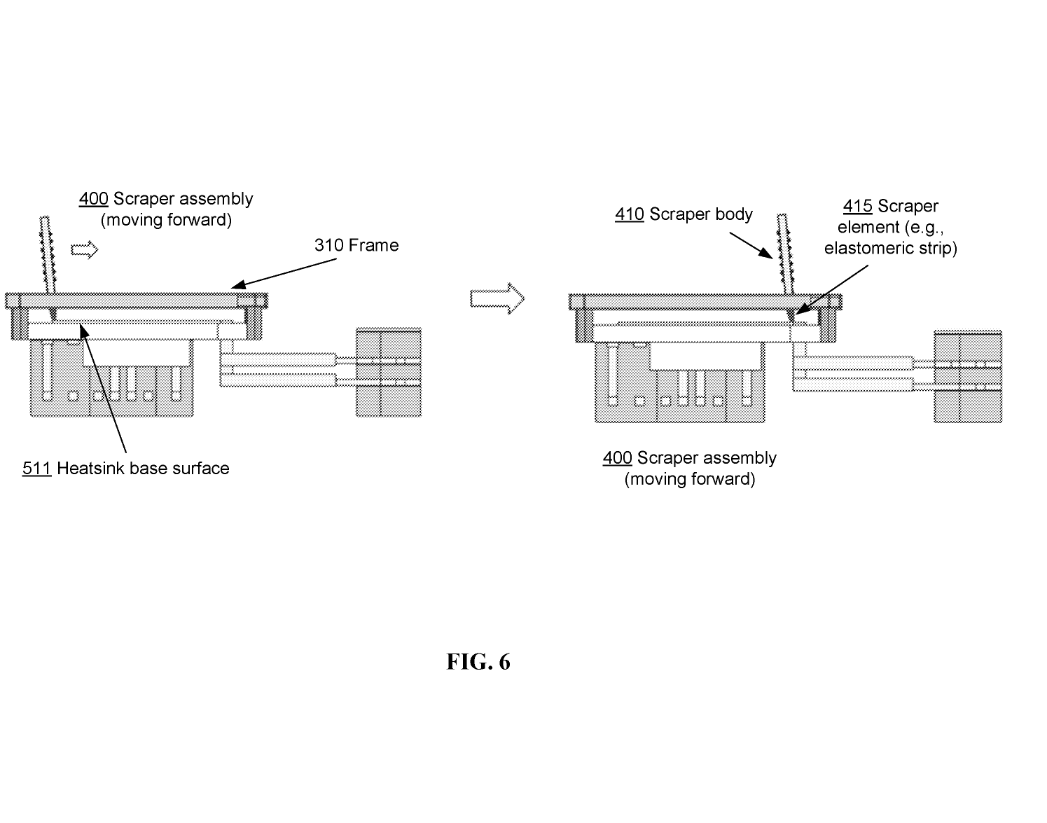

FIG. 6 illustrates side views that show movement of a scraper assembly relative to a heat sink base surface, in accordance with some embodiments.

As shown, a frame 310 of the thermal interface material removal fixture (e.g., 300) is clamped around a heat sink such that a heat sink base surface 511 is exposed within the opening of the frame 310. A scraper assembly 400 spans at least a portion of the opening and is configured to move forward across the heat sink base surface 511, as indicated by the arrows.

In some embodiments, the scraper assembly 400 includes a scraper body 410 and a scraper element 415. The scraper body 410 is a relatively rigid component that is coupled to the frame 310 via the guide structure (e.g., 350, not shown in detail in this view). In some embodiments, the scraper body 410 defines one or more channels that receive guide rods (e.g., 354) of the guide structure, thereby allowing the scraper assembly 400 to translate along an axis parallel to the guide rods (in some embodiments, rotate about an axis defined by the guide rods) while remaining supported by the frame 310. The engagement between the channels and the guide rods can also permit the scraper body 410 to rotate about an axis defined by the guide rods so that the scraper assembly 400 can be tilted to adjust the attack angle of the scraper element 415 relative to the heat sink base surface 511. For example, as the scraper assembly 400 moves forward, the scraper element 415 can be tilted slightly toward the direction of travel to improve scraping efficiency and control the contact pressure.

In some embodiments, the scraper element 415 is mounted to a lower portion of the scraper body 410 and is configured to directly contact the heat sink base surface 511 to remove thermal interface material. In some embodiments, the scraper element 415 is implemented as an elongate elastomeric strip formed from a compliant material such as silicone rubber, thermoplastic elastomer, polyurethane, or similar materials that are sufficiently soft to avoid scratching the metal base surface yet stiff enough to shear and collect residual thermal interface material. The elastomeric strip can be received in a mounting slot or groove defined by the scraper body 410 so that the scraper element 415 is friction-fit, clamped, or otherwise releasably retained. This arrangement allows a worn or contaminated scraper element 415 to be removed and replaced without replacing the entire scraper assembly 400.

During operation, with the frame 310 fixed relative to the heat sink and the scraper element 415 pressed against the heat sink base surface 511, an operator moves the scraper assembly 400 forward along the guide rods. The combination of translational motion, optional tilt of the scraper body 410 about the guide-rod axis, and the compliant contact of the elastomeric scraper element 415 facilitates efficient removal of thermal interface material from the base surface while reducing the risk of damage to the underlying heat sink.

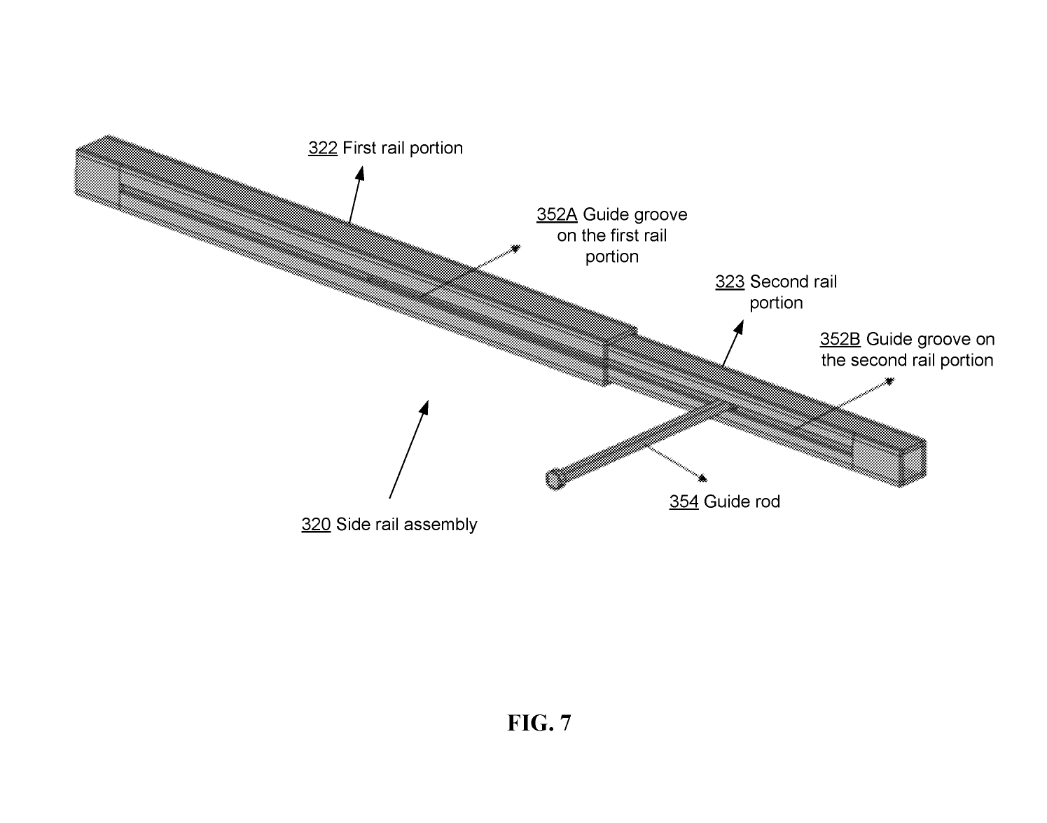

FIG. 7 illustrates an enlarged perspective view of a side rail assembly 320 illustrating details of a guide structure (e.g., 350) that supports the scraper assembly (e.g., 400). A side rail assembly 320 includes a first rail portion 322 and a second rail portion 323 that overlap telescopically. Each rail portion defines a respective guide groove: a first guide groove 352A formed along the first rail portion 322 and a second guide groove 352B formed along the second rail portion 323. The guide grooves 352A and 352B are aligned with one another so that, when the first and second rail portions slide relative to each other as the frame expands or contracts, the grooves cooperate to form a continuous track extending along the length of the side rail assembly 320.

As shown, a guide rod 354 is received in and supported by aligned guide grooves 352A, 352B such that the guide rod 354 extends generally perpendicular to a longitudinal direction of the side rail assembly 320. The guide grooves 352A, 352B cradle the guide rod 354 and constrain it laterally while permitting the guide rod 354 to roll and/or slide forward and backward along its own axis within the grooves. When the fixture 300 is assembled, the guide rod 354 on the illustrated side rail assembly 320 and a corresponding guide rod on an opposed side rail assembly (not shown in FIG. 7) together form a substantially parallel pair of guide rods that define a rotational axis for a joint of the scraper body. Channels or other bearing features on the scraper body engage the pair of guide rods 354, allowing the scraper assembly to translate along the guide rods for scraping motion and to pivot about the rod-defined axis to vary the angle of the scraper element relative to the heat sink base surface.

FIG. 8A is a front view of an example scraper assembly 400, illustrating details of the scraper body 410, scraper element 415, handle 815 (optional), and guide-rod engagement, in accordance with some embodiments.

In this embodiment, the scraper assembly 400 includes a scraper body 410 and a scraper element 415 coupled along a lower edge of the scraper body 410. The scraper element 415 may be implemented as an elongate elastomeric strip having a scraping edge configured to contact and remove thermal interface material from the base surface of a heat sink. When the fixture is clamped to the heat sink, the frame and guide structure cooperate to position the contact edge of the scraper element 415 in a plane substantially coincident with the base surface so that, as the scraper assembly 400 is moved, the elastomeric strip shears residual material without gouging the metal surface. As used herein, “substantially coincident” means that the contact edge of the scraper element 415 is aligned with the plane of the heat sink base surface within normal manufacturing tolerances and elastic compliance of the components, such that the scraper element 415 maintains effective contact across the base surface during scraping.

To support guided motion, the scraper body 410 defines one or more channels 810 that run laterally across the scraper assembly 400 and receive respective guide rods 354 of the guide structure. The engagement between the channels 810 and the guide rods 354 forms a joint that couples the scraper assembly 400 to the frame while allowing the scraper assembly 400 to translate along the guide rods for scraping strokes and to rotate about an axis defined by the pair of guide rods. By pivoting the scraper body 410 about this axis, an operator can vary the angle of the scraper element 415 relative to the base surface to tune the contact pressure and scraping performance. While FIG. 8A shows a pair of channels to respectively receive the corresponding rods, in some embodiments, the scraper body 410 may have one channel across its width to receive both rods.

In some embodiments, a handle 815 is mounted on an upper portion of the scraper body 410 and is sized and shaped to be grasped by an operator to apply a scraping force as the scraper assembly 400 is moved along the guide structure. At least one surface of the scraper body 410 includes a surface pattern 430, such as a series of ridges, ribs, or other textured features, configured to improve grip on the scraper assembly 400, especially when the operator’s hands are wet or contaminated with thermal interface material. In some embodiments, the handle 815 may also carry a textured surface pattern similar to the surface pattern 430 so that both the scraper body 410 and the handle 815 provide enhanced traction, thereby improving control and reducing the risk of slippage during scraping.

FIG. 8B is an exploded perspective view of the scraper body 410 and scraper element 415, in accordance with some embodiments. This figure highlights a mounting slot 420 that allows the scraper element 415 to be replaced. In this embodiment, the scraper body 410 defines an elongate mounting slot 420 along its lower edge (e.g., the edge for engaging with the scraper element 415). As shown, the mounting slot 420 is sized and shaped to receive a correspondingly shaped rib or tongue on the scraper element 415 so that the scraper element 415 can be slid or snapped into the slot from an end of the scraper body 410. The cooperation between the mounting slot 420 and the mating portion of the scraper element 415 provides a releasable retention structure that holds the scraper element 415 securely during scraping, yet allows the scraper element 415 to be removed and replaced when it becomes worn, contaminated, or when a different material or hardness is desired. In other embodiments, the scraper element 415 may be retained by a clamping bar and fasteners that press the scraper element into the mounting slot 420, or by a dovetail-shaped undercut in the mounting slot 420 that interlocks with a complementary dovetail rib on the scraper element 415.

As shown in FIG. 8B, the ribs on the scraper body 410 constitute a surface pattern that improves manual grip on the scraper body 410 to give the operator better control over the scraping force and angle during operation.

FIG. 9 illustrates that the scraper assembly 400 can be rotated to accommodate different scraping directions while the frame 310 and heat sink remain fixed, in accordance with some embodiments. As described above, the scraper body is coupled to the guide rods so that it can pivot about an axis defined by the pair of guide rods (e.g., 354 in FIG. 8A), thereby varying the angle of the scraper element (tip of the scraper assembly 400) relative to the base surface of the heat sink. In some embodiments, the joint between the scraper body and the guide rods allows the scraper assembly 400 to rotate through a range of about 0–60 degrees to either side of a nominal vertical orientation, as indicated by the curved arrows 910. In practice, an operator may tilt the scraper assembly 400 forward or backward to select a comfortable scraping angle for push strokes or pull strokes, to increase or decrease the contact pressure of the scraper element 415 on the heat sink base surface, or to conform to local features of the heat sink such as edges or raised structures. This adjustability allows the same fixture to be used effectively for scraping in different directions and along different portions of the base surface without loosening or repositioning the frame 310.

In addition to manual operation, in some embodiments the fixture further includes a drive mechanism configured to move the scraper assembly 400 along the guide structure 350. For example, a drive mechanism may be supported by the frame 310 and coupled to the scraper assembly 400 so that actuation of the drive mechanism produces controlled linear motion of the scraper assembly 400 along the guide rods 354. The drive mechanism can be configured to advance and retract the scraper assembly 400 over the full width of the heat sink base surface at a substantially constant speed and contact pressure, thereby improving consistency of thermal interface material removal and reducing operator fatigue.

In some embodiments, the drive mechanism includes an electric motor and a transmission that converts rotary motion of the motor shaft into linear movement of the scraper assembly 400 along the guide structure 350. By way of example, the transmission may comprise a lead screw and nut assembly, a rack-and-pinion arrangement, a toothed belt and pulley system, or a linear actuator that is fixed relative to the frame 310 and coupled to the scraper body 410. The scraper assembly 400 may be attached to a carriage or nut that travels along the guide rods 354 and is driven by the transmission, while the guide rods 354 continue to provide lateral support and the pivoting joint maintains the desired scraping angle. In some cases, the motor may be controlled by a simple forward/reverse switch or by a programmable controller that sets speed, stroke length, and number of passes to achieve a desired cleaning profile for different heat sink sizes and thermal interface materials.

In still other embodiments, the drive mechanism can be implemented as a removable module so that the same frame 310 and scraper assembly 400 may be operated either manually or under powered assist. For example, a clamp-on motor unit can engage a drive feature on the scraper body 410 or on a dedicated drive bar that spans between the guide rods 354. This modular approach allows technicians to use the fixture 300 in a purely manual mode in field environments where power is not readily available, while taking advantage of motorized, repeatable scraping motion in production or laboratory environments where higher throughput and consistency are desired.

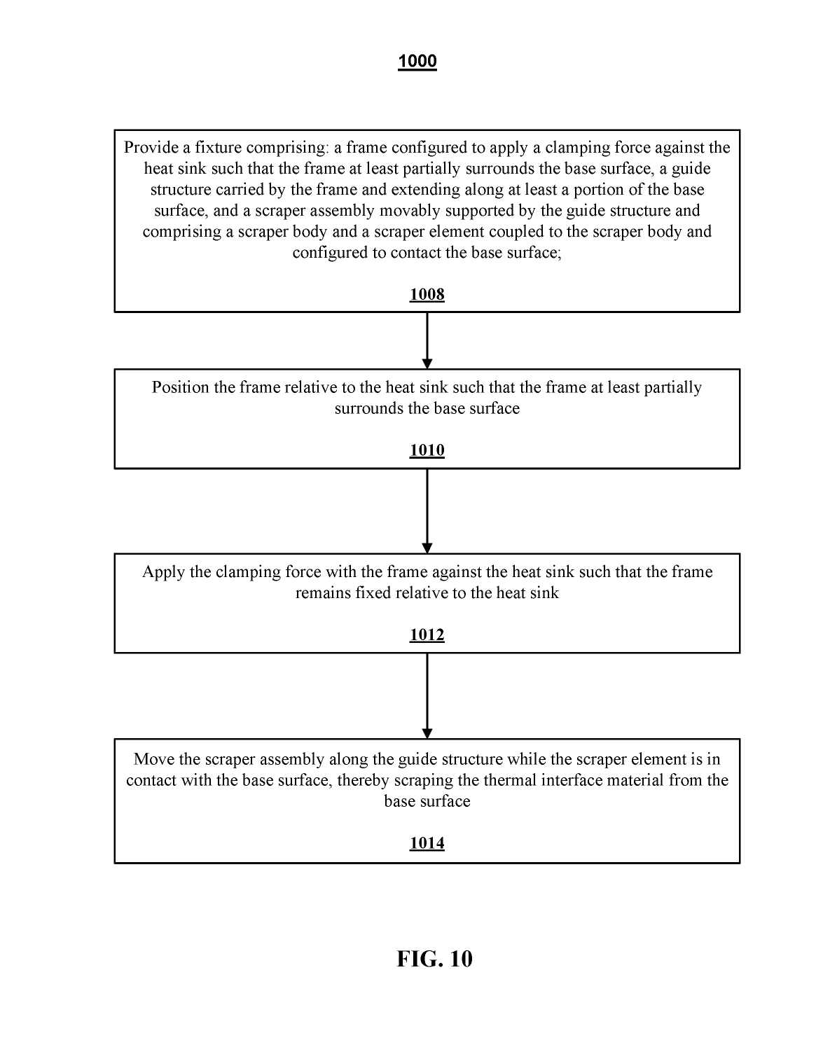

FIG. 10 illustrates a process 1000 for removing thermal interface material from a base surface of a heat sink using the fixture described above. The process 1000 begins at step 1008 by providing a fixture that includes a frame configured to apply a clamping force against a heat sink such that the frame at least partially surrounds a base surface of the heat sink, a guide structure carried by the frame and extending along at least a portion of the base surface, and a scraper assembly movably supported by the guide structure. The scraper assembly includes a scraper body and a scraper element coupled to the scraper body and configured to contact the base surface.

At step 1010, the frame is positioned relative to the heat sink such that the frame at least partially surrounds the base surface. In some embodiments, this includes aligning corner members of the frame with corresponding corner regions of the heat sink so that positioning surfaces and anti-slip pads on the corner members locate and stabilize the heat sink within the substantially rectangular opening defined by the frame.

At step 1012, a clamping force is applied with the frame against the heat sink such that the frame remains fixed relative to the heat sink during scraping. In embodiments that employ telescoping side rail assemblies with internal biasing elements, this step may include pulling opposing corners of the frame away from one another to extend at least two of the side rail assemblies against the tension of the biasing elements and enlarge the rectangular opening, placing the heat sink within the opening, and then releasing the corners so that the biasing elements retract the side rail assemblies toward a retracted configuration in which side surfaces of the heat sink are gripped and the frame is clamped to the heat sink.

At step 1014, the scraper assembly is moved along the guide structure while the scraper element remains in contact with the base surface, thereby scraping and removing thermal interface material from the base surface. This movement may be performed manually by an operator grasping the handle of the scraper assembly, or by a drive mechanism configured to translate the scraper assembly along the guide rods of the guide structure.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A fixture for removing thermal interface material from a base surface of a heat sink, comprising:
a frame configured to apply a clamping force against the heat sink such that the frame at least partially surrounds the base surface;
a guide structure carried by the frame; and
a scraper assembly movably supported by the guide structure and comprising a scraper body and a scraper element, the scraper element coupled to the scraper body and configured to contact the base surface;
wherein the scraper assembly is movable along the guide structure to scrape the thermal interface material from the base surface while the frame remains fixed relative to the heat sink.

2. The fixture of claim 1, wherein the frame comprises:
one or more side rail assemblies configured to cooperate with other portions of the frame to define an opening.

3. The fixture of claim 2, wherein the frame comprises:
a plurality of side rail assemblies joined end-to-end to define a substantially rectangular opening to receive the heat sink such that the base surface is exposed through the opening.

4. The fixture of claim 2, wherein each side rail assembly of the plurality of side rail assemblies comprises:
a first rail portion and a second rail portion that are telescopically received one within the other to permit adjustment of a length of the side rail assembly.

5. The fixture of claim 4, further comprising, within each side rail assembly of the plurality of side rail assemblies:
a biasing element extending between the first rail portion and the second rail portion and configured to urge the first rail portion and the second rail portion toward a retracted configuration in which the first rail portion and the second rail portion substantially overlap.

6. The fixture of claim 5, wherein the biasing element of each side rail assembly comprises:
a tension spring extending generally along the corresponding side rail assembly and having opposed ends respectively attached to the first rail portion and the second rail portion.

7. The fixture of claim 5, wherein the frame is configured such that, when diagonally opposite corners of the frame are pulled away from one another, at least two of the plurality of side rail assemblies extend against the biasing elements to enlarge the rectangular opening, and
when the diagonally opposite corners of the frame are released, the biasing elements return the side rail assemblies toward the retracted configuration to apply the clamping force against side surfaces of the heat sink.

8. The fixture of claim 3, further comprising:
a plurality of corner members respectively coupled to adjacent ones of the side rail assemblies, each corner member being perpendicular to a plane defined by the plurality of side rail assemblies and comprising at least one positioning surface configured to engage a corresponding corner region of the heat sink and locate the frame relative to the base surface.

9. The fixture of claim 8, wherein at least one of the corner members comprises an anti-slip pad configured to frictionally engage the heat sink and resist relative movement between the frame and the heat sink during scraping.

10. The fixture of claim 1, wherein the guide structure comprises:
a pair of substantially parallel guide grooves formed in opposed side rail assemblies of the frame, and
wherein the scraper assembly comprises a pair of guide rods respectively received in the pair of substantially parallel guide grooves.

11. The fixture of claim 1, wherein the scraper element comprises:
an elastomeric strip having a scraping edge configured to contact and remove the thermal interface material from the base surface.

12. The fixture of claim 11, wherein the scraper body defines a mounting slot configured to releasably retain the elastomeric strip such that the elastomeric strip is replaceable.

13. The fixture of claim 10, wherein the scraper assembly is coupled to the guide structure by a joint that permits rotation of the scraper body about an axis defined by the pair of guide rods to vary an angle of the scraper element relative to the base surface.

14. The fixture of claim 1, wherein the scraper assembly further comprises:
a handle configured to be grasped by an operator and to transmit a scraping force to the scraper element as the scraper assembly is moved along the guide structure.

15. The fixture of claim 1, wherein at least one surface of the scraper body comprises:
a surface pattern configured to improve manual grip on the scraper assembly.

16. The fixture of claim 14, wherein at least one of the scraper body and the handle comprises:
a textured surface pattern configured to improve manual grip on the scraper assembly.

17. The fixture of claim 1, wherein the frame and the guide structure cooperate to position a contact edge of the scraper element in a plane substantially coincident with the base surface of the heat sink when the clamping force is applied.

18. The fixture of claim 1, further comprising:
a drive mechanism configured to move the scraper assembly along the guide structure, wherein the drive mechanism comprises:
an electric motor and a transmission coupled between the electric motor and the scraper assembly to translate rotary motion of the electric motor into linear movement of the scraper assembly along the guide structure.

19. A method of removing thermal interface material from a base surface of a heat sink, the method comprising:
providing a fixture comprising a frame configured to apply a clamping force against the heat sink such that the frame at least partially surrounds the base surface, a guide structure carried by the frame, and a scraper assembly movably supported by the guide structure and comprising a scraper body and a scraper element, the scraper element coupled to the scraper body and configured to contact the base surface;
positioning the frame relative to the heat sink such that the frame at least partially surrounds the base surface;
applying the clamping force with the frame against the heat sink such that the frame remains fixed relative to the heat sink; and
moving the scraper assembly along the guide structure while the scraper element is in contact with the base surface, thereby scraping the thermal interface material from the base surface.

20. The method of claim 19, wherein applying the clamping force comprises:
pulling opposing corners of the frame away from one another to extend at least two side rail assemblies of the frame against respective biasing elements to enlarge a substantially rectangular opening of the frame,
positioning the heat sink within the substantially rectangular opening, and
releasing the opposing corners to allow the biasing elements to return the side rail assemblies toward a retracted configuration in which the side rail assemblies apply the clamping force against side surfaces of the heat sink.
